(19) United States
(12) Patent Application Publication
(10) Pub. No.: US 2005/0190683 A1
(43) Pub. Date: Sep. 1, 2005

(54) Method of manufacturing optical components

(75) Inventor: Masaki Ando, Chiba (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 11/050,889

(22) Filed: Jan. 27, 2005

(30) Foreign Application Priority Data
Feb. 10, 2004 (JP) P2004-033734

(51) Int. Cl. G11B 7/00

(52) U.S. Cl. 369/121

(57) ABSTRACT

According to a method of manufacturing optical components according to the related art, after a plurality of prisms was set to a fixing apparatus and temporarily removed from the fixing apparatus, bonding surfaces of the respective prisms and CCDs should be applied with adhesives and the prisms and the CCDs should be again set to the fixing apparatus. As a result, it takes a lot of time and labor to adjust position among the prisms and work efficiency is low. The present invention relates to a method of manufacturing optical components in which a plurality of optical devices are joined at a plurality of portions by using adhesives and thereby integrated. Adhesives with different properties are used for a plurality of portions and timings at which a plurality of adhesives is cured are changed depending upon the places in which they are in use.

### BACKGROUND OF THE INVENTION

1. Field of the Invention

The present invention relate generally to a method of manufacturing optical components integrated by joining a plurality of optical devices at a plurality of portions with an adhesive and, particularly to a method of manufacturing optical components in which a plurality of optical devices is requested to have high positional accuracy.

2. Description of the Related Art

A cited patent reference 1 has described this kind of optical components manufacturing method according to the related art. Specifically, the cited patent reference 1 has described a method of manufacturing a dichroic prism and a prism unit. The dichroic prism manufacturing method described in the cited patent reference 1 comprises a process for bonding a first triangular prism and a third triangular prism to form a first prism synthesized assembly in such a manner that a first exposed side surface may be formed on one end side of the bonded surface of the first and third triangular prisms, a process for bonding a second triangular prism and a fourth triangular prism to form a second prism synthesized assembly in such a manner that a second exposed side surface may be formed on one end side of the bonded surface of the second and fourth triangular prisms and a process for bonding the first prism synthesized assembly and the second prism synthesized assembly in such a manner that a third exposed side surface may be formed on a bonded surface of the first and second prisms.

According to the dichroic prism manufacturing method having the above-mentioned arrangement, it is to be expected that there can be achieved effects in which the prisms can be bonded together accurately and the center of the bonded prism can be determined accurately by using the first, second and third exposed side surfaces as a positioning reference plane used when the triangular prisms are bonded.

A cited patent reference 2 has described an apparatus including this kind of optical components according to the related art. More specifically, the cited patent reference 2 has described an optical system in which a prism-like optical device is properly positioned and supported by a substrate member and an optical device such as a projection type image display apparatus using such optical system. The optical system described in the cited patent reference 2 is an optical system comprising an optical device made by bonding a prism-like first optical device element and a prism-like second optical device element, each having its inside filled with an optical medium, and a substrate member for properly positioning and supporting the optical device. A chamfered-like surface is formed between the bonded surface of the first optical device element and the surface adjacent to the bonded surface and a chamfered-like surface is formed on the first optical device element of the bonded surface of the second optical device element and a positioning protrusion provided on the substrate member is brought in contact with at least one of the portion exposed by forming the chamfered-like surface on the first optical device element of the bonded surface of the second optical device element and the chamfered-like surface.

According to the optical system having the above-mentioned arrangement, since a part of the second optical device element can be exposed without increasing the size and weight of the optical device and without interrupting a bundle of effective lights passing the optical device, it is to be expected that the optical device can be positioned on the substrate with high accuracy by using the exposed portion and the chamfered-like surface.

[Cited patent reference 1]: Official gazette of Japanese laid-open patent application No. 2000-304909

[Cited patent reference 2]: Official gazette of Japanese laid-open patent application No. 2003-140087

However, in the above-mentioned optical assembly manufacturing method according to the related art, after the bonded surface between the prisms or the bonded surface between the prism and a solid-state image pickup device (CCD) was applied with the adhesive, the positions of the bonded surface and the solid-state image pickup device are adjusted properly and the adhesives are cured while an image outputted from the CCD is being monitored and all of the bonded surfaces are fixed by adhesives. As a result, positioning differences are produced by distortion generated when the adhesives are cured and when the adhesives are cured and contracted. Positioning differences are accumulated by the number of bonded surfaces so that a large positioning difference is generated.

In order to alleviate the positioning difference, it has been customary that, after prisms had been fixed together by adhesives, the prism and the CCD are fixed together by adhesives to absorb positioning difference, produced by fixing the prisms together with adhesives, when the prism and the CCD are fixed together by adhesives. In this case, after the prism once set to the fixing apparatus was removed, the bonded surface between the prism and the CCD should be applied with adhesives and the product should be again set to the fixing apparatus. Therefore, it takes a lot of time and labor to adjust the position between the prisms and work efficiency is lowered unavoidably.

### SUMMARY OF THE INVENTION

In view of the aforesaid aspect, it is an object of the present invention to provide a method of manufacturing optical components in which optical components in which a plurality of optical devices should be positioned with high accuracy can be manufactured with high accuracy and relatively easily.

It is another object of the present invention to provide a method of manufacturing optical components in which a color separation prism with high positional accuracy can be manufactured.

According to an aspect of the present invention, there is provided a method of manufacturing optical components integrated by joining a plurality of optical devices at a plurality of portions with an adhesive, comprising a step of changing a timing to be joined selectively depending on respective joining portions by applying two or more kinds of adhesives with different properties on the plurality of portions to be joined and by curing thereof.

According to the method of manufacturing optical components of the present invention, a plurality of adhesives with different properties is made by a combination of adhesives of which time period until they are cured since they were applied are different.

According to the method of manufacturing optical components of the present invention, a plurality of adhesives with different properties is made by a combination of different curing means for curing a plurality of adhesives after they were applied.

According to the method of manufacturing optical components of the present invention, a plurality of adhesives with different properties is made by a combination of an ultraviolet-curing resin adhesive cured with illumination of ultraviolet rays and a thermosetting resin adhesive cured by heating.

According to the method of manufacturing optical components of the present invention, a plurality of adhesives with different properties is made by a combination of adhesives cured after a predetermined time since they were applied and adhesives cured by curing means after they were applied.

According to the method of manufacturing optical components of the present invention, an optical component is a color separation prism formed by integrating a plurality of prism assemblies and solid-state image pickup devices joined to the prism assemblies and of which number is the same as that of the prism assemblies, a plurality of prism assemblies is attached to each other by a first adhesive, a plurality of solid-state image pickup devices is attached to a plurality of prism assemblies by a second adhesive with properties different from those of the first adhesive and any one of the first and second adhesives is cured earlier than the other.

Further, according to the method of manufacturing optical components of the present invention, the optical component is a color separation prism formed by integrating a plurality of prism assemblies, color separation filters joined to the prism assemblies and of which number is the same as that of the prism assemblies and solid-state image pickup devices jointed to the color separation filters and of which number is the same as that of the color separation filters, a plurality of prism assemblies is attached to each other by a first adhesive, a plurality of color separation filters is attached to a plurality of prism assemblies by the first adhesive, a plurality of solid-state image pickup devices is attached to a plurality of prism assemblies by a second adhesive with properties different from those of the first adhesive and any one of the first and second adhesives is cured earlier than the other.

Furthermore, according to the method of manufacturing optical components of the present invention, one of the first and second adhesives is a ultraviolet-curing resin adhesive cured with illumination of ultraviolet rays and the other is a thermosetting resin adhesive cured by heating and curing means for curing the ultraviolet-curing resin adhesive with illumination of ultraviolet rays and curing means for curing the thermosetting resin adhesive by heating are effected with a delay of time so that one of the ultraviolet-curing resin adhesive and the thermosetting curing resin adhesive is cured earlier than the other.

According to the present invention, since a plurality of optical devices is bonded to a plurality of portions with a plurality of adhesives with different curing properties, timing at which each adhesive is cured can be changed by using properties of these adhesives and hence it is possible to manufacture optical components with high positional accuracy by bonding a plurality of portions of a plurality of optical devices successively.

According to the present invention, since a combination of adhesives with properties in which they are cured with different curing time since they have been applied is used as a plurality of adhesives with different properties, a plurality of adhesives can be cured with a delay of time as time passes and hence a plurality of portions can be bonded successively.

According to the present invention, a combination of adhesives with properties in which they are cured by different curing means since they have been applied is used as a plurality of adhesives with different properties, a plurality of adhesives can be cured by different curing means with a delay of time and a plurality of portions can be bonded successively.

According to the present invention, since a ultraviolet-curing resin adhesive and a thermosetting resin adhesive can be used as a plurality of adhesives with different properties and the ultraviolet-curing resin adhesive can be cured by ultraviolet ray illumination curing means and the thermosetting resin adhesive can be cured by curing means using heating with a delay of time, it is possible to successively bond a plurality of portions by changing timing at which a plurality of adhesives can be cured.

According to the present invention, since a combination of adhesives cured for a predetermined time since they have been applied and adhesives cured by curing means after they were applied as a plurality of adhesives with different properties, it is possible to successively bond a plurality of portions by changing timing at which a plurality of adhesives can be cured.

According to the present invention, since a color separation prism formed by integrating a plurality of (two, three, four or more than five) prism assemblies and solid-state image pickup devices of the number same as that of the prism assemblies can be applied as optical components, after a plurality of prism assemblies was attached by a first adhesive and a plurality of solid-state image pickup devices was attached by a second adhesive, the first and second adhesives are cured with a delay of time and a plurality of portions can be successively bonded by changing timing at which the first and second adhesives are cured and the color separation prism with high positional accuracy can be manufactured.

Further, according to the present invention, since a color separation filter formed by integrating a plurality of (two, three, four or more than five) prism assemblies, color separation filters of the same number as that of the prism assemblies and solid-state image pickup devices of the same number as that of the color separation filters can be applied as optical components, after a plurality of prism assemblies and a plurality of color separation filters were bonded by a first adhesive and a plurality of solid-state image pickup devices was bonded by a second adhesive, the first and second adhesives are cured with a delay of time, whereby a plurality of portions can be bonded successively by changing timing at which the first and second adhesives are cured and a color separation prism with high positioning accuracy can be manufactured.

Furthermore, since one of the first and second adhesives can be formed of a ultraviolet-curing resin adhesive and the other can be formed of a thermosetting resin adhesive, the ultraviolet-curing resin adhesive is cured by curing means with illumination of ultraviolet rays and the thermosetting resin adhesive is cured by curing means using heating with a delay of time, whereby timing at which the ultraviolet-curing resin adhesive and the thermosetting resin adhesive can be cured is changed and a plurality of portions can be bonded successively. Hence, it is possible to manufacture a color separation prism with high positioning accuracy.

### BRIEF DESCRIPTION OF THE DRAWINGS

FIG. 1 is a perspective view showing a video camera as a specific example of an electronic device using a CCD prism assembly and illustrates optical components manufactured by a method of manufacturing optical components according to an embodiment of the present invention;

FIG. 2 is an explanatory diagram showing a 3CCD camera system mounted on the video camera shown in FIG. 1;

FIG. 3 is an explanatory diagram showing a three-chip system color separation prism having an air layer as optical components manufactured by a method of manufacturing optical components according to an embodiment of the present invention;

FIG. 4 is an explanatory diagram showing the state in which the three-chip system color separation prism shown in FIG. 3 is disassembled;

FIG. 5 is an explanatory diagram to which reference will be made in explaining a method of adjusting a positional relationship between a prism assembly of the three-chip system color separation prism shown in FIG. 3 and a solid-state image pickup device;

FIG. 6 is an explanatory diagram to which reference will be made in explaining a method of fixing the prism assembly of the three-chip system color separation prism shown in FIG. 3 and the solid-state image pickup device to each other;

FIG. 7 is an explanatory diagram showing a three-chip system color separation prism without air layer as optical components manufactured by a method of manufacturing optical components according to another embodiment of the present invention; and

FIG. 8 is an explanatory diagram showing the state in which the three-chip system color separation prism shown in FIG. 7 is disassembled.

### DESCRIPTION OF THE PREFERRED EMBODIMENTS

The present invention will now be described in detail with reference to the drawings.

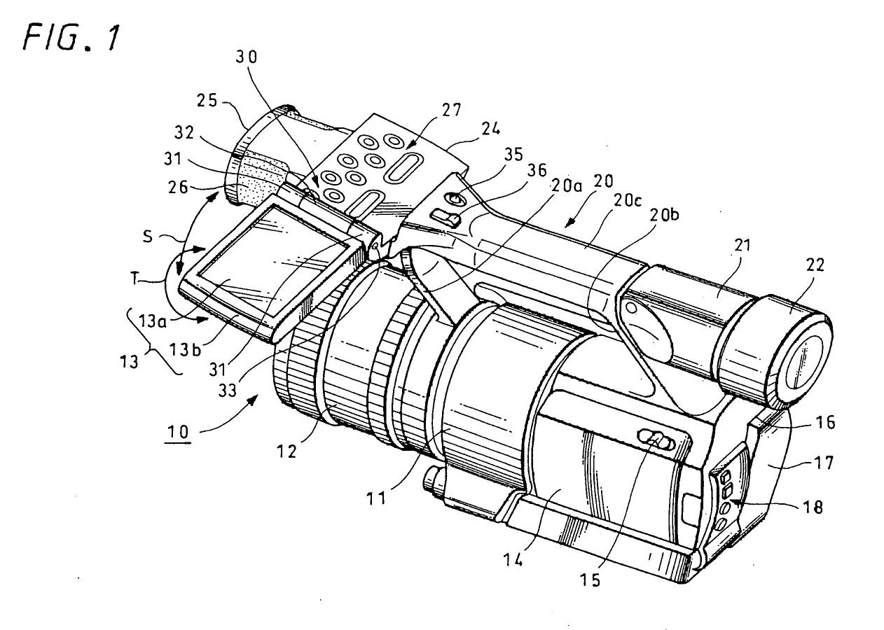

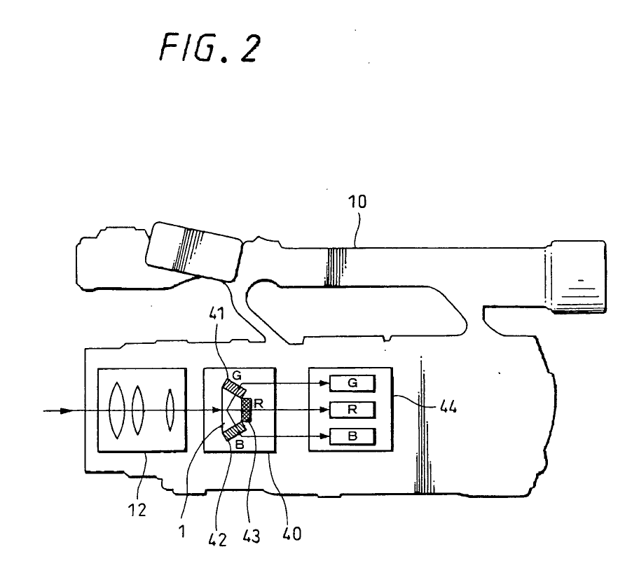

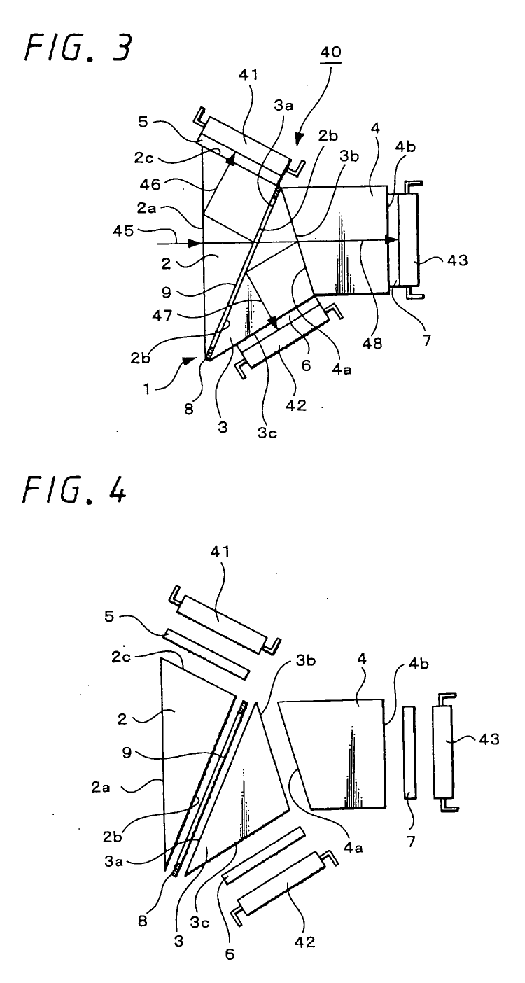

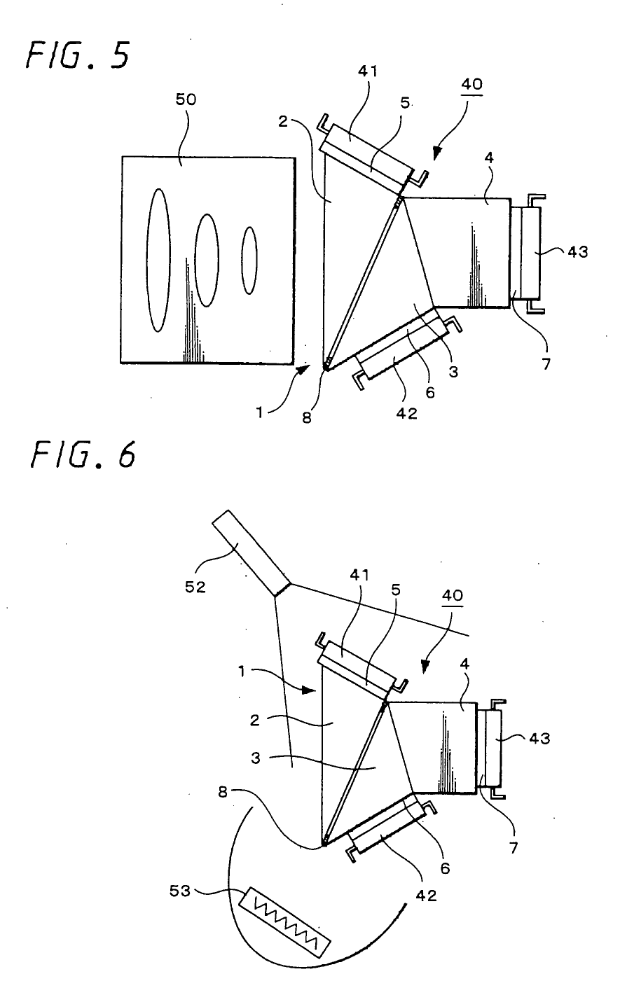

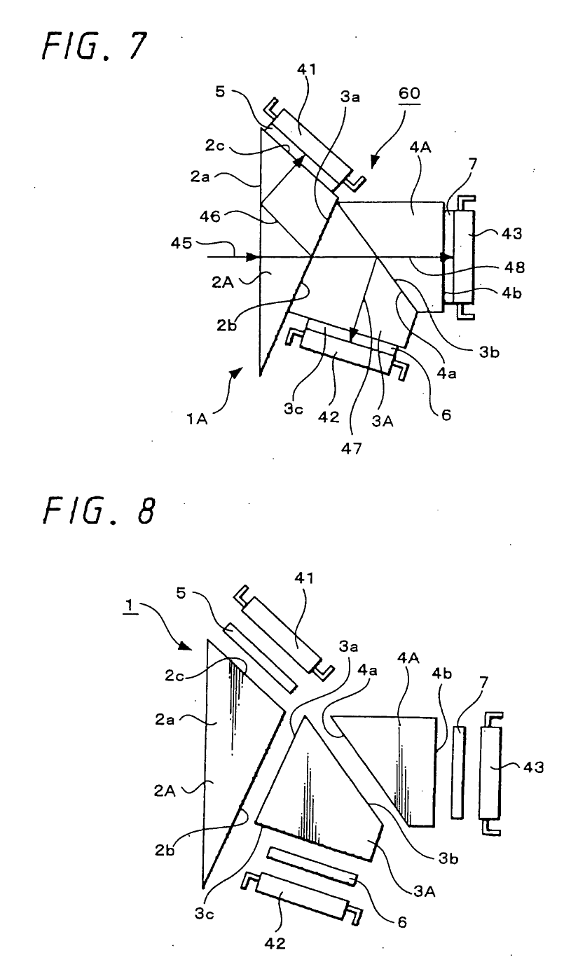

FIGS. 1 to 8 are diagrams showing the embodiments of the present invention. More specifically, FIG. 1 is a perspective view showing a video camera as a specific example of an electronic device using optical components manufactured by a method of manufacturing optical components according the present invention; FIG. 2 is an explanatory diagram showing a 3CCD camera system mounted on the video camera shown in FIG. 1; FIG. 3 is an explanatory diagram showing a three-chip system color separation prism as optical components manufactured by a method of manufacturing optical components according to an embodiment of the present invention; FIG. 4 is an explanatory diagram showing the state in which the three-chip system color separation prism shown in FIG. 3 is disassembled; FIG. 5 is an explanatory diagram to which reference will be made in explaining a method of adjusting a positional relationship between a prism assembly and a solid-state image pickup device; FIG. 6 is an explanatory diagram to which reference will be made in explaining a method of fixing the prism assembly and the solid-state image pickup device to each other; FIG. 7 is an explanatory diagram showing a three-chip system color separation prism as optical components manufactured by a method of manufacturing optical components according to another embodiment of the present invention; and FIG. 8 is an explanatory diagram showing the state in which the three-chip system color separation prism shown in FIG. 7 is disassembled.

First, a video camera which shows a specific example of an electronic device using optical components manufactured by a method of manufacturing optical components according to the present invention will be described.

A video camera, generally depicted by reference numeral 10 in FIG. 1, uses a digital video cassette (hereinafter simply referred to as a “DV cassette”) using a tape-like recording medium as an information recording medium and it uses a CCD (charge-coupled device), which shows a specific example of a solid-state image pickup device, to convert an optical image into an electric signal so that the electric signal can be recorded on the DV cassette or it can be displayed on a display apparatus such as a liquid-crystal display apparatus. Optical components manufactured by the method of manufacturing optical components according to the present invention can be realized as a three-chip system color separation prism 1 for use with the video camera 10. A solid-state image pickup device according to the present invention is not limited to the CCD, which will be described in this embodiment, and it is needles to say that a solid-state image pickup device may be other image pickup devices such as a MOS (metal-oxide semiconductor) type solid-state image pickup device and a CMOS (complementary MOS) type solid-state image pickup device.

However, the optical components manufactured by the optical component manufacturing method according to the present invention are not limited to a three-chip system color separation prism shown as first and second embodiments, which will be described in detail later on, but the optical component manufacturing method according to the present invention can be applied to a method of manufacturing various kinds of optical components such as a dichroic prism, a polarizing beam splitter or an assembly made by a combination of the dichroic prism, the polarizing beam splitter and a liquid-crystal panel. Further, the optical component manufacturing method according to the present invention can be similarly applied to electronic devices using such optical components. The optical component manufacturing method according to the present invention is not limited to a video camera which will be described next but it can also be applied to an electronic still camera and other image pickup apparatus and it is needless to say that the optical component manufacturing method according to the present invention can be applied to a video projector, a surveillance camera and other electronic component.

As shown in FIG. 1, this video camera 10 is composed of a case main body 11 formed of a hollow housing assembly, a lens apparatus 12 attached to the front of the case main body 11 so as to project to the front, an image pickup means for generating a video signal of an object based upon light inputted from the lens apparatus 12, a display apparatus 13 for displaying an image based upon a video signal generated from this image pickup means or information previously recorded on an information recording medium (storage apparatus or DV cassette, etc.) and the like.

An image pickup means of the video camera 10 is composed of a cassette holder accommodated within the case main body 11 and to and from which the DV cassette can be freely loaded and unloaded, a recording and reproducing apparatus for recording (writing) an information on and reproducing (reading) an information from a tape-like recording medium of the DV cassette loaded onto this cassette holder while the tape-like recording medium is being transported, a control apparatus for controlling driving of this recording and reproducing apparatus and the like although not shown. As shown in FIG. 2, the recording and reproducing apparatus of the image pickup means includes a three-chip system color separation prism 1 for separating light introduced through the lens apparatus 12 into three primary colors of a red component, a blue component and a green component and three CCDs (solid-state image pickup devices) 41, 42 and 43 for detecting the thus separated respective color components.

As shown in FIG. 2, the three CCDs 41, 42 and 43 are unitarily fixed to the color separation prism 1, and an integrated CCD prism assembly (optical component) 40 is located behind the optical axis of the lens apparatus 12. Video information converted into an electric signal by the CCD prism assembly 40 is recorded on the DV cassette or displayed on the display apparatus 13.

The case main body 11 has an opening portion formed on its one side surface to load or unload the DV cassette, and the opening portion can be freely opened and closed by an openable and closable lid 14 rotatably attached to the case main body 11. A cassette holder for freely loading and unloading the DV cassette is located on the inside of the opening portion of the case main body 11. The cassette holder can be inclined with a proper inclination angle in unison with opening and closing operations of the openable and closable lid 14. As this openable and closable lid 14 is opened, the cassette holder is inclined to expose a cassette insertion slot set at the upper end, whereby the DV cassette can be loaded into the cassette holder.

On the other hand, when the openable and closable lid 14 is pushed toward the inside with pressure, the opening portion is closed by the openable and closable lid 14 while the cassette holder is being housed into the case main body 11. The openable and closable lid 14 can be opened automatically by sliding a lid open button 15. As shown in FIG. 1, this lid open button 15 is attached to the upper portion of the openable and closable lid 14. As the lid open button 15 is slid, the openable and closable lid 14 is released from being locked and the upper portion of the operable and closable lid 14 is inclined to the lateral direction of the case main body 11 to open the cassette insertion slot in the upper direction.

As shown in FIG. 1, the case main body 11 has a battery compartment portion 16, formed of a dented recess portion, provided on the back at its side opposite to the openable and closable lid 14. A battery 17 is detachably loaded into the battery compartment portion as a power supply. The case main body 11 has a large number of operation buttons (for example, a volume control button, a white balance button, a mode switch button, etc.) 18 provided on its back at the side where the openable and closable lid 14 is provided.

The case main body 11 has a grip 20 integrally formed with its upper portion so as to be extended in the front and back direction which is the optical axis direction of the lens apparatus 20. The grip 20 is composed of a front leg portion 20a erected on the front upper portion of the case main body 11, a rear leg portion 20b erected on the rear upper portion of the case main body 11 and a grip portion 20c for joining the upper ends between the front leg portion 20a and the rear leg portion 20b. An electronic viewfinder 21 is attached to the upper portion of the rear leg portion 20b of the grip 20. The electronic viewfinder 21 is projected into the rearward of the optical axis direction and an eyecup 22 is attached to the tip end portion of the electronic viewfinder 21. The electronic viewfinder 21 is supported to the rear leg portion 20b so as to become freely rotatable so that the side of the eyecup 22 can be rotated approximately 80 degrees in the upper direction.

A pedestal portion 24 continuing the tip end of the grip portion 20c is disposed on the front end portion of the grip 20 and a protruded portion 25 is continued to the tip end of the pedestal portion 24 so as to project in the front of the optical axis direction. The protruded portion 25 is formed of a hollow portion opened in the front, left and right sides and houses a microphone 26 in the inside thereof. Also, the pedestal portion 24 is formed relatively large so as to expand to both sides of the direction crossing the optical axis direction. The pedestal portion 24 has a dented recess portion opened to the upper surface. A lid assembly including an operation button group 27 composed of a large number of operation buttons is integrally fitted into and fixed to the pedestal portion 24.

The upper surface of the lid assembly mounted on the pedestal portion 24 is formed in such a manner that its height may be increased in the front side of the optical axis direction and may be progressively decreased in the back side. Consequently, a cameraman's eyes can become substantially vertical to the surface of the lid assembly while the cameraman is holding up the video camera 10 in the breast. As specific contents of the operation button group 27 provided on this lid assembly, there can be enumerated a play button, a stop button, a fast-forward button, a rewind button, a pause button, a volume control switch, a backlight switch, etc.

A liquid-crystal display 13, which shows a specific example of the display apparatus, is attached to one side portion of the pedestal portion 24 through a rotation supporting portion 30 such that it can be rotated and reversed. The liquid-crystal display 13 includes a display portion 13a to display pictures and a case portion 13b having an opening portion to expose this display portion 13a. The case portion 13b is joined to the rotation supporting portion 30. The rotation supporting portion 30 is composed of a first rotating portion for rotating the liquid-crystal display 13 relative to the pedestal portion 24 in the right and left direction S which is the direction perpendicular to the optical axis direction and a second rotating portion for rotating the liquid-crystal display 13 relative to the pedestal portion 24 in the front and back direction T which is the optical axis direction.

The first rotating portion is composed of a pair of bearing portions 31, 31 provided on one side portion of the pedestal portion 24 with a predetermined spacing therebetween, a bearing member 32 interposed between the two bearing portions 31 and 31 and a first rotary shaft 33 penetrating the pair of bearing portions 31, 31 and the bearing member 32. The liquid-crystal display 13 can be rotated in the direction perpendicular to the axial line direction of the first rotary shaft 33 in an angular extent of approximately 180 degrees in the right and left direction S. As a result, the liquid-crystal display 13 can be placed in the “display closed state” in which the case surface opposite to the display portion 13a appears on the front side, and the liquid-crystal display 13 can be rotated 180 degrees in the right and left direction and placed in the “display opened state” in which the display portion 13a appears in the front side as shown in FIG. 2.

The second rotating portion is composed of a bearing member 32, a second rotary shaft (not shown) erected on this bearing member 32 and a rotary friction mechanism (not shown) for generating frictional force between the second rotary shaft and the case portion 13b so that the liquid-crystal display 13 can be held at an arbitrary angle. The second rotary shaft is extended in the direction perpendicular to the axial line direction of the first rotary shaft 33, whereby the liquid-crystal display 13 can be rotated in an angular extent of approximately 270 degrees in the front and back direction T.

As a result, after the liquid-crystal display 13 was rotated 90 degrees in the backward in the state in which the display portion 13a is directed to the back (normal shooting state) from the state in which the display portion 13a is directed upward as shown in FIG. 2, when the liquid-crystal display 13 is further rotated 90 degrees in the backward, the liquid-crystal display 13 can be placed in the state in which the case surface is exposed to the upper side (display portion 13a is directed downward) and the liquid-crystal display panel 13 is rotated 270 degrees in the opposite direction from the state so that it can be placed in the state in which the display portion 13a is directed to the front (the state in which a cameraman can take a picture of the cameraman).

Also, when the liquid-crystal display 13 is rotated 180 degrees in the right and left direction from the state in which the display portion 13a is directed downward so as to expose the case surface in the upper side, the liquid-crystal display 13 can be placed in the state in which the liquid-crystal display 13 is put on the pedestal portion 24, the display portion 13a being exposed to the upper side. When the display portion 13a of the liquid-crystal display 13 is directed to the object (when the cameraman takes a picture of the cameraman), the change-over switch is actuated to automatically invert the image.

A recording button 35 which shows a specific example of an operation button for operating the image pickup means and a zoom button 36 which shows a specific example of an operation button for operating the lens apparatus 12 are provided on the front end portion of the grip portion 20c of the grip 20 in the vicinity of the liquid-crystal display 13 supported by the pedestal 24 such that its attitude can be changed.

The recording button 35 and the zoom button 36 are disposed side by side so that the cameraman can operate the recording button 35 and the zoom button 36 with the thumb without changing the holding state of the video camera 10 in the state in which the cameraman holds the video camera 10 with the grip 20. The recording button 35 and the zoom button 36 are a second recording button and a second zoom button disposed on the grip 20 in order to make the video camera 10 become easier to handle. To this end, a second recording button and a second zoom button are independently provided on the upper side surface of the case main body 11 at the opposite side of the openable and closable lid 14.

FIG. 2 is a schematic diagram used to explain a relationship between the lens apparatus 12 and a CCD prism assembly 40 accommodated within the case main body 11 of the video camera 10 having the above-mentioned arrangement is located in the backward on the optical axis of the lens apparatus 12. Light introduced into the CCD prism assembly 40 from the lens apparatus 12 is separated into three primary colors of green component light (G), blue component light (B) and red component light (R) by the three-chip system color separation prism 1. Information corresponding to the respective color component lights separated by this color separation prism 1 is separately inputted into corresponding three CCDs 41, 42 and 43, respectively. Information signals corresponding to the respective color component lights of G, B and R are outputted from the three CCDs 41, 42 and 43 and these information signals are inputted into a color signal processing circuit 44.

This color signal processing circuit 14 effects predetermined signal processing on the information signals and then a predetermined video signal is outputted to and displayed on the display apparatus 13 as an image or a predetermined video signal is recorded on the recording medium of the DV cassette. The CCD prism assembly 40 for outputting information signals corresponding to the respective color component lights after light has been separated into the three primary colors of G, B and R has an arrangement shown in FIGS. 3 and 4.

FIGS. 3 and 4 are schematic diagrams showing the CCD prism assembly 40 from the direction perpendicular to the optical axis direction of the lens apparatus 12. As illustrated, this CCD prism assembly 40 is of the type including the three-chip system color separation prism 1 in which a gap (air layer) is provided between the prisms. The CCD prism assembly 40 is composed of the three prism assemblies 2, 3, 4, the three color separation filters 5, 6, 7, the spacer 8 and the three CCDs 41, 42 and 43.

The first prism assembly 2 is a first prism through which incident light 45 passes and it picks up only light of a green component from the incident light 45 introduced thereto from the lens apparatus 12. The first prism assembly 2 is triangular in plane shape and includes an incident surface 2a on which light passed the lens apparatus 12 becomes incident, a reflection and transparent surface 2b for reflecting only color component light with a specific wavelength (light formed of a green component with a wavelength of approximately 500 nm: G) of the incident light and which passes remaining color component lights and a light emitting end face 2c from which the reflected green component light 46 is emitted to the outside.

The three surfaces of the light incident surface 2a, the light reflection and transparent surface 2b and the light emitting surface 2c of the first prism assembly 2 are finished as mirror surfaces by a suitable treatment such as mirror polishing. Further, a dielectric multilayer film with wavelength selection properties is formed on the light reflection and transparent surface 2b by a treatment method such as a vacuum deposition in order to reflect only the green component light G, which shows a specific example of the color component light with the specific wavelength of the incident light 45 and in order to pass other color component lights (in this embodiment, light formed of a blue component with a wavelength of substantially 450 nm: B and light formed of a red component with a wavelength of substantially 650 nm: R).

As a result, in the first prism assembly 2, light introduced from the incident surface 2a is introduced into the light reflection and transparent surface 2b in which only the green component light 46 is reflected and the reflected light 46 is reflected on the incident light surface 2a. The reflected light 46 reflected on the light incident surface 2a is introduced into the light emitting surface 2c and emitted from the light emitting surface 2c to the outside of the prism. Of the incident light 45, light containing the remaining blue component N and red component R is passed through the first prism assembly 2 and emitted from the reflection and transparent surface 2b.

The second prism assembly 3 is a second prism through which the incident light 45 passes and picks up only light of a blue component of the light passed through the first prism assembly 2. The second prism assembly 3 is triangular in plane shape and includes an incident and reflection surface 3a on which light passed the first prism assembly 2 becomes incident, a light reflection and transparent surface 3b for reflecting only color component light with a specific wavelength (light formed of a blue component with a wavelength of substantially 450 nm: B) 47 of the incident light and a light emitting surface 3c from which the reflected blue component light 47 is emitted to the outside.

The three surfaces of the light incident and reflection surface 3a, the light reflection and transparent surface 3b and the light emitting surface 3c of the second prism assembly 3 are finished as mirror surfaces by a suitable treatment such as mirror polishing. Further, a dielectric multilayer film with wavelength selection properties is formed on the light reflection and transparent surface 3b by a treatment method such as a vacuum deposition in order to reflect only the blue component light 47, which shows a specific example of the color component light with the specific wavelength of the incident light and in order to pass other color component lights (in this embodiment, light formed of a red component with a wavelength of substantially 650 nm: R).

As a consequence, in the second prism assembly 3, of the light incident on the second prism assembly 3 from the light incident and reflection surface 3a, only the blue component light 47 is reflected on the light reflection and transparent surface 3b and the reflected light 47 is reflected on the light incident and reflection surface 3a. The reflected light 47 reflected on the light incident and reflection surface 3a is introduced into the light emitting surface 3c and is emitted from the light emitting surface 3c to the outside of the prism. Also, of the remaining incident light, light formed of only the red component R is directly passed through the second prism assembly 3 and emitted from the reflection and transparent surface 3b.

The third prism assembly 4 is the third prism through which the incident light 45 passes and it picks up light of the remaining red component of the light that has passed through the second prism assembly 3. The third prism assembly 4 is square in plane shape and includes a light incident surface 4a into which light passed the second prism assembly 3 is introduced and a light emitting surface 4b for directly emitting color component light with a specific wavelength (in this embodiment, light formed of a red component with a wavelength of substantially 650 nm: R) of the incident light to the outside. The two surfaces of the incident light surface 4a and the light emitting surface 4b of the third prism assembly 4 are treated as optical mirror surfaces by a suitable treatment such as polishing. As a result, in the third prism assembly 4, red component light 48 introduced from the light incident surface 4a into the third prism assembly 4 is directly introduced into the light emitting surface 4b and emitted from the light emitting surface 4b to the outside of the prism.

The spacer 8 is interposed between the light reflection and transparent surface 2b of the first prism assembly 2 and the light incident and reflection surface 3a of the second prism assembly 3 in order to form an air layer 9 having a thickness of about 10 microns so that the green component light 46 may be totally reflected. The spacer 8 used in this embodiment is a spacer formed of a square plate-like member shaped like a frame. However, the shape and structure of the spacer 8 are not limited to those of this embodiment. For example, a wire-like member, a granular-like member and the like may be used. These members may be interposed between the prism assemblies to form a clearance and an air layer may be formed by such clearance. When the air layer is formed by using the granular-like member, the granular-like member may be contained in an adhesive in use. Thus, it is possible to simplify the air layer molding process.

Of the three prism assemblies having the shapes and the structures, the first prism assembly 2 and the second prism assembly 3 are bonded together through the spacer 8 by an adhesive. On the other hand, the second prism assembly 3 and the third prism assembly 4 are directly bonded together by the adhesive. The color separation filters 5, 6 and 7 used to adjust spectral characteristics of the respective color components are respectively bonded to the respective light emitting surfaces 2c, 3c and 4b of the three prism assemblies 2, 3 and 4. Further, the CCDs 41, 42 and 43 are respectively bonded to the three color separation filters 5, 6 and 7.

More specifically, the first color separation filter 5 is bonded to the light emitting surface 2c of the first prism assembly 2 by the adhesive, and the first CCD 41 is bonded to the first color separation filter 5 by the adhesive. Similarly, the second color separation filter 6 is bonded to the light emitting surface 3c of the second prism assembly 3 by the adhesive, and the second CCD 42 is bonded to the second color separation filter 6 by the adhesive. Then, the third color separation filter 7 is bonded to the light emitting surface 4b of the third prism assembly 4 by the adhesive, and the third CCD 43 is bonded to the third color separation filter 7 by the adhesive.

As shown in FIG. 3, the first prism assembly 2 and the first CCD 41 are adjusted in positional relationship such that the optical axes of the green component lights 46 passing them may agree with each other. A positional relationship between the second prism assembly 3 and the second CCD 42 is adjusted such that the optical axes of the blue component lights 47 passing them may agree with each other. Similarly, a positional relationship between the third prism assembly 4 and the third CCD 43 is adjusted in such a manner that the optical axes of the red component lights 48 passing them may agree with each other. A positional relationship among the three CCDs 41, 42 and 43 is adjusted in such a manner that the focusing screens of the CCDS 41, 42 and 43 may become the same focusing screen.

A bonding method of the three-chip system color separation prism 1 having the above-described arrangement will be described next. First, in order to provide the air layer 9 on the light reflection and transparent surface 2b of the first prism assembly 2, the spacer 8 is bonded to and fixed to the light reflection and transparent surface 2b. If the air layer 9 is thick, such thick air layer 9 lowers focusing performance of the prism assembly. Therefore, it is desired that the air layer 9 should be made as thin as possible. Considering accuracy in processing the spacer 8 and work efficiency in attaching the spacer 8, it is suitable that the thickness of the air layer 9 should be set to approximately 10 microns. As the adhesive for bonding the spacer 8 to the light reflection and transparent surface 2b, there may be used a thermosetting resin adhesive or a two-liquid curing type resin adhesive.

Next, the first adhesive is applied on the spacer 8 bonded to the first prism body 2, the light incident and reflection surface 3a of the second prism assembly 3 is attached to the first adhesive, they are aligned coarsely and held by a predetermined jig. Next, the first adhesive is applied on the light emitting surface 3b of the second prism assembly 3, the light incident surface 4a of the third prism assembly 4 is attached to the first adhesive and they are positioned coarsely and held by a predetermined jig.

Next, a method of bonding the CCDs 41 to 43 to the color separation prism 1 will be described. First, the first adhesive is applied on the light emitting surface 2c of the first prism assembly 2 and the first color separation filter 5 is attached to the light emitting surface 2c. Subsequently, the second adhesive is applied on the first color separation filter 5 and the first CCD 41 is attached to the first color separation filter 5. In a similar manner, the first adhesive is applied on the light emitting surface 3c of the second prism assembly 3 and the second color separation filter 6 is attached to the second prism assembly 3. Subsequently, the second adhesive is applied on the second color separation filter 6 and the second CCD 42 is attached to the second color separation filter 6. Further, the first adhesive is applied on the light emitting surface 4b of the third prism assembly 4 and the third color separation filter 7 is attached to the light emitting surface 4b of the third prism assembly 4. Subsequently, the second adhesive is applied on the third color separation filter 7 and the third CCD 43 is attached to the third color separation filter 7.

The above-described three color separation filters 5, 6 and 7 are not always used depending upon required color separation characteristics. In that case, the second adhesive may be applied on the three light emitting surfaces 2c, 3c and 4c of the color separation prism 1.

Also, the first and second adhesives with different properties are used in the present invention. As the adhesives with different properties, there can be enumerated adhesives which are cured with different times since the adhesives have been applied. In this case, adhesives with different curing times may contain of course adhesives made of different materials and may contain adhesives containing the same chemical component so long as they are cured with different curing times. To be concrete, there can be enumerated a combination of arbitrary two adhesives of an epoxy-based adhesive, a silicon-based adhesive and a phenol-based adhesive.

Further, as adhesives with different properties, there can be enumerated adhesives with different curing means. For example, there can be enumerated a combination of a ultraviolet-curing resin adhesive cured with illumination of ultraviolet rays and a thermosetting resin adhesive cured by heating. To be concrete, there can be enumerated a ultraviolet-curing resin adhesive manufactured by KYORITU CHEMICAL & COMPANY LIMITED under the trade name of “WORLD ROCK”. This ultraviolet-curing resin adhesive is an ultraviolet-curing type epoxy-based adhesive (chemical name) and its main gradient is composed of epoxy oligomer, UV reactive monomer, additive, photopolymerization initiator and the like. Also, as the thermosetting resin adhesive, there can be enumerated the aforementioned epoxy-based adhesive, silicon-based adhesive and phenol-based adhesive and the like.

Furthermore, a combination of adhesives with different properties may be a combination of adhesive cured for a predetermined time since it has been applied and adhesive cured by curing means after it has been applied. That is, two kinds of adhesives can be applied to the present invention so long as curing timings of the first and second adhesives can be set freely to some extent and adjusted.

In the embodiment shown in FIGS. 3 to 8, the ultraviolet-curing resin adhesive is used as the first adhesive and the thermosetting resin adhesive is used as the second adhesive. However, the present invention is not limited thereto and it is needless to say that the thermosetting resin adhesive can be used as the first adhesive and the ultraviolet-curing resin adhesive is used as the second adhesive.

Next, a method of adjusting position of the CCD prism assembly temporarily fixed by the two kinds of adhesives as mentioned before will be described. According to this position adjustment method, a positional relationship among the color separation prism 1 and the CCDs 41 to 43 can be adjusted. With an adjustment jig having predetermined functions (not shown), the three prism assemblies 2 to 4 and the three CCDs 41 to 43 are held by an axis adjustment mechanism which can adjust the prism assemblies 2 to 4 and the CCDs 41 to 43 in the three-axis directions (X-axis direction and Y-axis direction which are perpendicular to each other and θ direction which is rotation direction) and the three color separation filters 5 to 7 can be held by an adjustment mechanism which can adjust the three color separation filters 5 to 7 in the two-axis directions (X-axis direction and Y-axis direction), respectively.

Next, as shown in FIG. 5, a focusing optical apparatus 50 is located on the image pickup side of the color separation prism 1 and the color separation prism 1 and the focusing optical apparatus 50 are set such that the focusing device screen and the focusing screen may agree with each other substantially. Thereafter, a test chart with positional information is focused on the three CCDs 41 to 43 by the focusing optical apparatus 50 and thereby the focused test chart image is stored in the apparatus. Then, in order that the test chart patterns may coincide with each other perfectly in the three CCDs 41 to 43, the three prism assemblies 2 to 4 and the three CCDs 41 to 43 are adjusted in the three-axis directions by the axis adjustment mechanism.

At the same time or before and after the three prism assemblies 2 to 4 and the three CCDs 41 to 43 are adjusted, the three color separation filters 5 to 7 also are adjusted in the two-axis directions by the axis adjustment mechanism. However, since the positions within the bonded surfaces of the three color separation filters 5 to 7 do not directly affect the focusing performance, the adjustment accuracy thereof may be adjusted with low accuracy as compared with that of the three prism assemblies 2 to 4 and the three CCDs 41 to 43.

Next, a method of fixing the three prism assemblies 2 to 4 and the three CCDs 41 to 43 will be described. FIG. 6 is a schematic diagram used to explain this fixing method. As shown in FIG. 6, an ultraviolet ray generating apparatus 52 serving as a first curing means and a heating apparatus 53 serving as a second curing means are located. The ultraviolet ray generating apparatus 52 is located in such a manner that radiated ultraviolet rays may be equally illuminated on the whole of the color separation prism 1. Also, the heating apparatus 53 is located in such a manner that the heating apparatus 53 may heat equally the whole of the color separation prism 1 similarly.

In such state, first, the ultraviolet ray generating apparatus 52 is energized to illuminate ultraviolet rays having intensity peak at the wavelength of 365 nm on the whole of the color separation prism 1 of which position was adjusted by the aforementioned method, and the ultraviolet-curing resin adhesive is cured with illumination of ultraviolet rays. At that time, since strain and curing shrinkage are generated when the ultraviolet-curing resin adhesive is cured, the fixed position obtained after adjustment does not completely agree with the fixed position which will be expected before the ultraviolet-curing resin adhesive is cured. As a result, although the difference of adjustment position is generated, since the thermosetting resin adhesive which is the second adhesive is not cured yet at that time, such positional difference can be absorbed to some extent by curing of the next second adhesive.

Next, the heating apparatus 53 is energized to heat the whole of the color separation prism 1 obtained after the ultraviolet-curing resin adhesive was cured and the thermosetting resin adhesive is cured by such heating. At that time, since the three CCDs 41 to 43 can be moved (positions can be adjusted), the positions of the three CCDs 41 to 43 can be adjusted in such a manner that a positional difference generated by strain and curing shrinkage produced when the aforementioned ultraviolet-curing resin adhesive may be corrected and the test chart patterns may agree with each other completely. Then, the whole of the color separation prism 1 is heated up to the temperature at which the thermosetting resin adhesive is fixed and the three CCDs 41 to 43 are respectively bonded to the three color separation filters 5 to 7.

According to this embodiment, although strain and curing shrinkage are generated when the CCDs 41 to 43 are fixed finally, since the place in which strain and curing shrinkage are produced is limited to the minimum as compared with the method according to the related art, it is possible to decrease the integrated positional difference amount of the whole of the CCD prism assembly 40. In addition, since all fixing works can be completed in the state in which elements and parts are set to the adjustment jigs, the number of adjustment processes can be reduced and the manufacturing process can be simplified.

FIGS. 7 and 8 are schematic diagrams used to explain a second embodiment of the present invention. According to the second embodiment, the aforementioned spacer 8 in the first embodiment can be discarded and the structure of the CCD prism assembly can be simplified.

A CCD prism assembly 60 is of the type including a three-chip system color separation prism 1A with the gap (air layer) between the prisms being removed. From a constituent standpoint, this CCD prism assembly 60 is similar to the CCD prism assembly 40 according to the first embodiment and is different from the first embodiment only in that the spacer 8 is removed. That is, although the CCD prism assembly 60 is composed of three prism assemblies 2A, 3A, 4A, three color separation filters 5, 6, 7 and three CCDs 41, 42, 43, the shape of the second prism assembly 3A is changed slightly. In CCD prism 60, elements and parts identical to those of the aforementioned CCD prism assembly 40 are denoted by identical reference numerals and therefore need not be described.

The first prism assembly 2A has substantially similar shape and structure to those of the aforementioned first prism assembly 2 and includes a light incident surface 2a, a light reflection and transparent surface 2b and the light emitting surface 2c. The first color separation filter 5 is fixed to the light emitting surface 2c of the first prism assembly 2A and the first CCD 41 is fixed to the first color separation filter 5. Also, the third prism assembly 4A also has substantially similar shape and structure to those of the third prism assembly 4 and includes the light incident surface 4A and the light emitting surface 4b. Then, the third color separation filter 7 is fixed to the light emitting surface 4b of the third prism assembly 4A and the third CCD 43 is fixed to the third color separation filter 7.

The second prism assembly 3A is slightly different from the second prism assembly 3 in shape and is square in plane shape. Of the four surfaces, the three surfaces of the second prism assembly 3A are used as a light incident and reflection surface 3a, a light reflection and transparent surface 3b and a light emitting surface 3c. The light incident and reflection surface 3a of the second prism assembly 3 is directly bonded to the light reflection and transparent surface 2b of the first prism assembly 2A, the light reflection and transparent surface 3b is disposed on one side of this light incident and reflection surface 3a and the light emitting surface 3c is disposed on the other side. Then, the second color separation filter 6 is fixed to the light emitting surface 3c of the second prism assembly 3A and the second CCD 42 is fixed to the second color separation filter 6.

The CCD prism assembly 60 having the above-mentioned arrangement can achieve action and effects similar to those of the CCD prism assembly 40 according to the aforementioned first embodiment. While green component light is separated by the first prism assemblies 2 and 2A, blue component light is separated by the second prism assemblies 3 and 3A and remaining red component light is passed through the third prism assemblies 4 and 4A in the first and second embodiments, the present invention is not limited thereto and the order in which each component light is separated can be set arbitrarily.

As described above, according to the related-art method, after the attachment positions of the three prisms and the three solid-state image pickup devices were all adjusted at the same time, the adhesives for bonding the three prisms and the three solid-state image pickup device should be fixed at the same time so that high adjustment accuracy has been requested. On the other hand, according to the present invention, the three prisms and the three solid-state image pickup devices can be fixed in a multistage fashion by one setting. Therefore, the adjustment accuracy of the attachment positions of the three prisms and the three solid-state image pickup devices can be increased and the number of adjustment processes can be decreased.

Further, while the present invention is applied to the three-chip system color separation prism in which the three image pickup devices are bonded to the three prisms in the aforementioned embodiments, the present invention is not limited thereto and it is needless to say that the present invention can be applied to an optical component obtained by bonding two or four or more than five prisms and/or image pickup devices.

For example, as the case in which two image pickup devices are in use, there can be enumerated a case in which so-called Y/C separation type optical component for separating an input video signal into a chrominance signal and luminance signals is in use or a case in which one image pickup device is used exclusively for green component light and one image pickup device is used exclusively for red and blue component lights. Also, as the case in which more than four image pickup devices are in use, there can be enumerated a case in which three image pickup devices for red, blue and green component lights and an image pickup device for color of the fourth color called red negative insensitivity, that is, emerald green, that is, totally four image pickup devices are used and a case in which totally four image pickup devices are used to sense more than two frequencies which result from separating one of red, blue and green component lights. Thus, the number of image pickup devices can be arbitrarily increased according to the need.

The present invention is not limited to the aforementioned embodiments and can be variously modified without departing from the gist of the present invention. While the present invention is applied to the manufacturing process of the CCD prism assembly for use with the image pickup means of the video camera as described above, the present invention is not limited thereto and the present invention can be applied to a manufacturing process of an optical assembly in which three or four solid-state image pickup devices are bonded to a dichroic prism or a manufacturing process of an optical component such as a polarizing beam splitter.

According to the present invention, since a plurality of optical devices is bonded to a plurality of portions with a plurality of adhesives with different curing properties, timing at which each adhesive is cured can be changed by using properties of these adhesives and hence it is possible to manufacture optical components with high positional accuracy by bonding a plurality of portions of a plurality of optical devices successively.

According to the present invention, since a combination of adhesives with properties in which they are cured with different curing time since they have been applied is used as a plurality of adhesives with different properties, a plurality of adhesives can be cured with a delay of time as time passes and hence a plurality of portions can be bonded successively.

According to the present invention, a combination of adhesives with properties in which they are cured by different curing means since they have been applied is used as a plurality of adhesives with different properties, a plurality of adhesives can be cured by different curing means with a delay of time and a plurality of portions can be bonded successively.

According to the present invention, since an ultraviolet-curing resin adhesive and a thermosetting resin adhesive can be used as a plurality of adhesives with different properties and the ultraviolet-curing resin adhesive can be cured by ultraviolet ray illumination curing means and the thermosetting resin adhesive can be cured by curing means using heating with a delay of time, it is possible to successively bond a plurality of portions by changing timing at which a plurality of adhesives can be cured.

According to the present invention, since a combination of adhesives cured for a predetermined time since they have been applied and adhesives cured by curing means after they were applied as a plurality of adhesives with different properties, it is possible to successively bond a plurality of portions by changing timing at which a plurality of adhesives can be cured.

According to the present invention, since a color separation prism formed by integrating a plurality of (two, three, four or more than five) prism assemblies and solid-state image pickup devices of the number same as that of the prism assemblies can be applied as optical components, after a plurality of prism assemblies was attached by a first adhesive and a plurality of solid-state image pickup devices was attached by a second adhesive, the first and second adhesives are cured with a delay of time and a plurality of portions can be successively bonded by changing timing at which the first and second adhesives are cured and the color separation prism with high positional accuracy can be manufactured.

Further, according to the present invention, since a color separation filter formed by integrating a plurality of (two, three, four or more than five) prism assemblies, color separation filters of the same number as that of the prism assemblies and solid-state image pickup devices of the same number as that of the color separation filters can be applied as optical components, after a plurality of prism assemblies and a plurality of color separation filters were bonded by a first adhesive and a plurality of solid-state image pickup devices was bonded by a second adhesive, the first and second adhesives are cured with a delay of time, whereby a plurality of portions can be bonded successively by changing timing at which the first and second adhesives are cured and a color separation prism with high positioning accuracy can be manufactured.

Furthermore, since one of the first and second adhesives can be formed of a ultraviolet-curing resin adhesive and the other can be formed of a thermosetting resin adhesive, the ultraviolet-curing resin adhesive is cured by curing means with illumination of ultraviolet rays and the thermosetting resin adhesive is cured by curing means using heating with a delay of time, whereby timing at which the ultraviolet-curing resin adhesive and the thermosetting resin adhesive can be cured is changed and a plurality of portions can be bonded successively. Hence, it is possible to manufacture a color separation prism with high positioning accuracy.

Having described preferred embodiments of the invention with reference to the accompanying drawings, it is to be understood that the invention is not limited to those precise embodiments and that various changes and modifications could be effected therein by one skilled in the art without departing from the spirit or scope of the invention as defined in the appended claims.

1. A method of manufacturing optical components integrated by joining a plurality of optical devices at a plurality of portions with an adhesive, comprising a step of:
changing a timing to be joined selectively depending on respective joining portions by applying two or more kinds of adhesives with different properties on said plurality of portions to be joined and by curing thereof.

2. A method of manufacturing optical components according to claim 1, wherein said plurality of adhesives with different properties is made by a combination of adhesives of which time period until they are cured since they were applied are different.

3. A method of manufacturing optical components according to claim 1, wherein said plurality of adhesives with different properties is made by a combination of different curing means for curing said plurality of adhesives after they were applied.

4. A method of manufacturing optical components according to claim 3, wherein said plurality of adhesives with different properties is made by a combination of a ultraviolet-curing resin adhesive cured with illumination of ultraviolet rays and a thermosetting resin adhesive cured by heating.

5. A method of manufacturing optical components according to claim 1, wherein said plurality of adhesives with different properties is made by a combination of adhesives cured after a predetermined time since they were applied and adhesives cured by curing means after they were applied.

6. A method of manufacturing optical components according to claim 1, wherein said optical component is a color separation prism formed by integrating a plurality of prism assemblies and solid-state image pickup devices joined to said prism assemblies and of which number is the same as that of said prism assemblies, said plurality of prism assemblies is attached to each other by a first adhesive, said plurality of solid-state image pickup devices is attached to said plurality of prism assemblies by a second adhesive with properties different from those of said first adhesive and any one of said first and second adhesives is cured earlier than the other.

7. A method of manufacturing optical components according to claim 1, wherein said optical component is a color separation prism formed by integrating a plurality of prism assemblies, color separation filters joined to said prism assemblies and of which number is the same as that of said prism assemblies and solid-state image pickup devices jointed to said color separation filters and of which number is the same as that of said color separation filters, said plurality of prism assemblies is attached to each other by a first adhesive, said plurality of color separation filters is attached to said plurality of prism assemblies by said first adhesive, said plurality of solid-state image pickup devices is attached to said plurality of prism assemblies by a second adhesive with properties different from those of said first adhesive and any one of said first and second adhesives is cured earlier than the other.

8. A method of manufacturing optical components according to claim 6 or 7, wherein one of said first and second adhesives is a ultraviolet-curing resin adhesive cured with illumination of ultraviolet rays and the other is a thermosetting resin adhesive cured by heating and curing means for curing said ultraviolet-curing resin adhesive with illumination of ultraviolet rays and curing means for curing said thermosetting resin adhesive by heating are effected with a delay of time so that one of said ultraviolet-curing resin adhesive and said thermosetting curing resin adhesive is cured earlier than the other.
